(19) United States
(12) Patent Application Publication
(10) Pub. No.: US 2023/0098618 A1
(43) Pub. Date: Mar. 30, 2023

(54) COMPOSITE MATERIAL WITH MOLTEN POLYMER BARRIER EFFECT AND WITH FLAME-RETARDANT PROPERTIES, AND METHOD FOR MAKING SUCH A COMPOSITE MATERIAL

(71) Applicant: O.R.V. MANUFACTURING S.P.A., Carmignano di Brenta (IT)

(72) Inventors: Francesca BELTRAME, Carmignano di Brenta (IT); Paolo MOCELLIN, Carmignano di Brenta (IT)

(21) Appl. No.: 17/950,590

(22) Filed: Sep. 22, 2022

(30) Foreign Application Priority Data
Sep. 24, 2021 (IT) 102021000024572

(51) Int. Cl. B32B 5/26; B32B 5/02; B32B 7/14; B32B 37/12

(52) U.S. Cl. CPC B32B 5/266; B32B 5/022; B32B 7/14; B32B 37/1292; B32B 37/1207; B32B 2307/3065; B32B 2307/718; B32B 2307/732; B32B 2262/0223; B32B 2307/724; B32B 2262/144; B32B 2262/0276; B32B 2307/102; B32B 2262/0261; B32B 2262/04; B32B 2307/54; B32B 2262/124; B32B 2305/18; B32B 2331/00; B32B 2367/00; B32B 2377/00; B32B 2317/18; B32B 2250/02; B32B 2250/20

(57) ABSTRACT

A composite material having a molten polymer barrier effect with flame-retardant properties includes a first layer of non-woven fabric having 40% or more by weight of oxidized polyacrylonitrile fibers to confer flame-retardant properties. The first layer has a basis weight of 200-600 g/m2 and a thickness of 1.6-5 mm. A barrier layer overlaps the first layer and counteracts passage of molten polymer. The first layers oxidized polyacrylonitrile fibers have a count of 1.5-5 dtex and the other first layer synthetic fibers have a count of 0.8-5 dtex. The barrier layer includes a second layer of non-woven fabric of hydro-entangled synthetic and/or artificial fibers. The barrier layer has a basis weight of 70-150 g/m2; a thickness of 0.4-1.5 mm; and a permeability of 200 L/m2s-2000 L/m2s under a pressure drop of 2 mbar. The composite material has a thickness of 2-6.5 mm, and a basis weight of 270-750 g/m2.

### CROSS-REFERENCE TO RELATED APPLICATION

This application claims the benefit of Serial No. 102021000024572, filed 24 Sep. 2021 in Italy and which application is incorporated herein by reference. To the extent appropriate, a claim of priority is made to the above disclosed application.

### FIELD OF APPLICATION

The present invention relates to a composite material with a molten polymer barrier effect and with flame-retardant properties and to a method for making such a composite material.

Advantageously, the composite material according to the present invention combines properties of heat resistance and a molten polymer barrier effect with a surprisingly high sound absorption capacity.

The composite material according to the present invention also exhibits characteristics of improved molten polymer barrier effect compared to existing products on the market, while also having excellent sound absorption characteristics.

Thus, the composite material according to the invention is a sound-absorbing, heat-insulating, non-flammable, moldable material that may be used in various applications where parts having thermal and sound absorption characteristics are required to be made by injection molding of plastics material.

In particular, the composite material according to the present invention may be used for the production of automotive parts by plastics material injection molding processes. In particular, the composite material according to the invention may be used in car interior parts, engine compartments, wheel arches, lower engine compartments, underbodies, or may even be used for civil engineering or for building materials.

Thus, the composite material of the present invention is suitable for satisfying plastics material molding applications in an innovative way:
the molded parts may be brought into contact with components that reach high temperatures because they are thermally insulated by the special fibers used (oxidized polyacrylonitrile), preventing thermal degradation;
the molded parts have the ability to acoustically attenuate/absorb any noise produced by the various engine components.

More specifically, the applications for which the composite material according to the invention is particularly suitable are therefore molding of plastics components for engine compartment or body linings of cars or other machinery, even where insulation of complex geometries is required. In particular, in the engine area it is an excellent thermal barrier and sound absorber, preventing any possible fires in the event of overheating.

### PRIOR ART

In the automotive industry, the use of non-woven fabrics has been widespread for many years in response to numerous applications. In order to provide the various characteristics needed for the specific applications of non-woven fabrics, their properties are being continuously improved.

One of the known applications is the use of very homogeneous, thin, compact, and low-basis-weight non-woven fabrics which, when coupled with the visible fabrics inside the passenger compartment (e.g., overhead linings, headliners and pillars, etc.), allow the external aesthetic part to be protected from the passage of molten polymer (e.g., polypropylene) during the injection molding of the components (“barrier” effect).

The “barrier” effect of the non-woven fabrics to the passage of molten polymer, while essential in these processes, does not allow them to be used individually in molding processes of components for the interior of the engine compartment/lower engine compartment/underbody because they would not be able to achieve the performance necessarily required for these areas of the car, namely fire resistance and heat resistance.

One solution currently known to combine the two requirements of heat resistance and molten polymer barrier effect is to use non-woven fabrics containing oxidized polyacrylonitrile fibers (henceforth oxidized PAN fibers). These are fibers obtained by the carbon fiber manufacturing process from precursors, such as polyacrylonitrile (PAN).

Oxidized polyacrylonitrile (PAN) fibers, which are thermally stabilized due to their unique chemical structure, are known not to burn, melt, soften or drip. With an LOT (limiting oxygen index) of 45 to 55%, oxidized PAN fibers are far superior to other organic fibers and have a high flammability rating.

In addition, the special oxidized fibers mixed with other types of fibers in different percentages provide a non-woven fabric having high thermal barrier capacities.

International application WO2020245735A1, relating to non-flammable thermoformable products with thermal insulation capacities, also points out that a thermoplastic polymer layer (e.g., polyester copolymers, polyethylene, etc.) may be deposited on these oxidized PAN fiber-based non-woven fabrics in the form of powder or by coating; this polymer layer acts as a barrier layer, limiting the passage of molten material used for the molding process.

This type of material, although it provides a high resistance to fire and heat, does not, however, guarantee an optimal barrier effect during the molding step: in fact, the distribution of the thermoplastic material is not completely homogeneous and due to the very nature of the powder or coating system, may leave some points uncovered where the passage of the molten polymer is defined, generating irregularities and defects during the manufacture of the part.

Encapsulation of the engine area, as well as that of other parts of the car, turns out to be necessary to ensure not only high fire resistance and effective heat retention but also significant noise reduction.

The need to develop products that exhibit both acoustic and thermal performance has led to a search for composite materials that may combine the characteristics of different types of products.

A material that acts as a sound absorber must properly adhere to the car part, avoiding leaving uncovered areas where acoustic performance becomes insufficient.

It is well known that polyurethane foams allow proper adhesion to the part during the molding step; moreover, normally combined with synthetic resins (such as classic phenolic or melamine resins), they create a barrier effect on the surface of the materials. Foams, however, have low sound insulation and generate toxic gases in case of fire.

In the automotive industry in particular, but also in other sectors, there is therefore a great need, which hitherto remained substantially unmet, for a composite material that combines high properties of heat resistance and barrier effect during the molding step with high sound absorption capacity.

### DISCLOSURE OF THE INVENTION

Therefore, the main purpose of the present invention is to eliminate all or part of the drawbacks of the above-mentioned known technique by making available a composite material with a molten polymer barrier effect and flame-retardant properties that exhibits high sound absorption capacity.

A further purpose of the present invention is to make available a composite material with a molten polymer barrier effect and with flame-retardant properties that allows improving the barrier effect to the passage of plastics material.

A further purpose of the present invention is to provide a composite material with a molten polymer barrier effect and with flame-retardant properties that is easy to manufacture.

### BRIEF DESCRIPTION OF THE DRAWINGS

The technical features of the invention, according to the aforesaid objects, may be clearly seen in the contents of the claims below, and its advantages will become more readily apparent in the detailed description that follows, made with reference to the accompanying drawings, which represent one or more purely exemplifying and non-limiting embodiments thereof, wherein:

FIGS. 1 to 10 show, in graph form, the measurement and sound absorption test results in different samples of the composite material according to the invention;

FIG. 11 shows a schematic representation of the structure of the composite material in accordance with a first embodiment of the invention, in which a first layer of NWF and a barrier layer of NWF are overlapped on one another but not solidarized;

FIG. 12 shows a schematic representation of the structure of the composite material in accordance with a second alternative embodiment of the invention, in which a first layer of NWF and a barrier layer of NWF are overlapped on one another and solidarized by islands of binder resin (not depicted to scale for illustrative reasons) interposed between the two layers; the free space between the two layers has been shown only to allow for graphical representation of the islands and does not correspond to a gap between the two layers);

FIG. 13 shows a schematic representation of the structure of the composite material in accordance with a third alternative embodiment of the invention, in which a first layer of NWF and a barrier layer of NWF are overlapped on one another and solidarized by bridge structures between the fibers of the two layers consisting of bicomponent fibers (depicted schematically and not to scale for illustrative reasons; the free space between the two layers has been shown only to allow for graphical representation of the bridge structures and does not correspond to a gap between the two layers); and

FIG. 14 shows a photograph of an NWF barrier layer on which powdered binder resin was deposited by scattering dispenser.

### DETAILED DESCRIPTION

The composite material with a molten polymer barrier effect and with flame-retardant properties according to the invention has been indicated overall by 1 in the attached figures.

In accordance with a general embodiment of the invention, the composite material 1 comprises a first layer 10 of non-woven fabric (NWF).

In turn, such first layer 10 made of NWF comprises a percentage by weight of oxidized polyacrylonitrile (oxidized PAN) fibers equal to or greater than 40%. The remaining percentage by weight consists of other synthetic fibers.

The first layer 10 confers flame-retardant properties to the composite material 1. In fact, due to the presence of at least 40% by weight of oxidized polyacrylonitrile (oxidized PAN) fibers (which have already undergone a controlled heat treatment that prevents their further deterioration when exposed to major heat sources), the first layer 10 exhibits flame-retardant properties and resistance to thermal wear.

The other synthetic fibers of the first layer 10 made of NWF may be selected from the group consisting of polyethylene terephthalate (PET) fibers, polybutylene terephthalate (PBT) fibers, polyethylene naphthalate (PEN) fibers, polycyclohexylenedimethylene terephthalate (PCT) fibers, polytrimethylene terephthalate (PTT) fibers, polytrimethylene naphthalate (PTN) fibers, and polypropylene (PP) fibers. Preferably, the synthetic fibers of said first layer 10 are polyethylene terephthalate (PET) fibers.

Advantageously, the synthetic fibers of said first layer 10 may further comprise bicomponent fibers.

Bicomponent fibers are defined as fibers consisting of two polymers having different melting temperatures.

Bicomponent fibers may have different cross-sections: in the form of adjacent segments (side-by-side); in the form of concentric layers (core-sheath); in the form of fibrils and matrix (island in the sea, segmented). The bicomponent fibers may also be of a different chemical composition (CoPET/PET, PP/PE, PE/PET, etc.). (Russel, S. J. (2007) Handbook of nonwovens, Woodhead Publishing)

Preferably, bicomponent fibers are CoPET/PET core-sheath fibers in which the core is PET (melting T about 255° C.), and the casing is CoPET (melting T 110° C.)

Preferably, the bicomponent fibers are present with a percentage by weight on the first layer 10 from 20% to 40%. As will be discussed below, the presence of the bicomponent fibers is intended to allow thermobonding between the first layer 10 and the barrier layer 20.

The first layer 10 has a basis weight between 200 g/m2 and 600 g/m2 and a thickness between 1.6 mm and 5 mm.

Also in accordance with the above-mentioned general embodiment of the invention, the composite material 1 also comprises a barrier layer 20, overlapping said first layer 10 made of NWF and suitable to counteract the passage of molten polymers through said composite material 1.

As pointed out earlier, from an application point of view, the composite material 1 is therefore intended to be inserted in an injection mold and molded with a polymer. The composite material 1 is to be placed in the mold so that it is the barrier layer 20 that meets the molding polymer melt. In this way, the first layer 10 comprising oxidized PAN fibers is shielded by the barrier layer 20 and is not affected by the molten polymer.

According to a first aspect of the invention, the oxidized polyacrylonitrile (oxidized PAN) fibers of said first layer 10 have a count between 1.5-5 dtex, preferably between 1.7 and 2.5 dtex, while the other synthetic fibers of said first layer 10 have a count between 0.8 dtex and 5 dtex.

According to a further aspect of the invention, the barrier layer 20 consists of a second layer of non-woven fabric of hydro-entangled synthetic and/or artificial fibers.

A non-woven fabric of hydro-entangled fibers is itself well known to a person skilled in the art and therefore will not be described in greater detail. It is merely noted that hydro-entanglement is a process of binding fibers by a high-speed/pressure water jet system. An entangled product is synonymous with a spunlace product or a product bonded by water jets (Russel, S. J. (2007) Handbook of nonwovens, Woodhead Publishing).

As mentioned above, the barrier layer 20 is suitable to counteract the passage of molten polymer through said composite material 1. Such a barrier layer 20 thus has the function of a barrier during plastics injection molding processes by preventing the molten polymer from reaching the first layer 10, thus reducing its flame resistance properties.

It has been experimentally verified that non-woven fabrics made with the spunlace (hydro-entanglement) system have shown effective barrier capacity due to their structure that ensures high elongations, and thus adaptability to complex geometric shapes, with low basis weights and low thicknesses, and above all high homogeneity in fiber distribution and surface smoothing.

In addition, due to the structure conferred by the hydro-entanglement process, the barrier layer 20 made of NWT ensures high elongations, and thus adaptability to complex geometric shapes.

According to the invention, the above-mentioned barrier layer 20 made of NWF has:
a basis weight between 70 g/m2 and 150 g/m2;
a thickness between 0.4 mm and 1.5 mm; and
a permeability to air between 200 L/m2s and 2000 L/m2s under a pressure drop of 2 mbar, measured in accordance with ISO 9237.

The composite material 1, resulting from the combination of the first layer 10 made of NWF and the barrier layer 20 made of NWF, has a thickness between 2 mm and 6.5 mm, preferably 3 mm, and a basis weight between 270 g/m2 and 750 g/m2, preferably between 450 g/m2 and 600 g/m2.

It was surprisingly verified that the composite material 1 resulting from the combination of the first layer 10 made of NWF and the barrier layer 20 made of NWF not only exhibits high molten polymer barrier capacities and flame-retardant properties, but also a high sound absorption capacity compared with similar products on the market, made as described in international application WO2020245735. All of this is supported by the experimental tests that will be described below.

Without wishing to be limited to the present explanation, it is hypothesized that the high sound absorption capacity of the composite material 1 results from the synergistic effect between the two layers 10 and 20 made of NWF. In particular, such a high sound absorption capacity of the composite material 1 would seem to result from the combination of:
the fibrous structure of the first layer 10 made of NWF obtained from the mixture of oxidized PAN fibers with a count between 1.5-5 dtex and other synthetic fibers with a count between 0.8 dtex and 5 dtex;
the fibrous structure of the barrier layer 20 made of hydro-entangled NWF having a permeability to air between 200 L/m2s and 2000 L/m2s under a pressure drop of 2 mbar, measured in accordance with ISO 9237.

A person skilled in the art is able to make the barrier layer 20 in NWF by adjusting the basis weight, thickness and type of fibers along with the setting parameters of the hydro-entanglement machine (pressure and type of water nozzles, temperatures, calendering, etc.). In fact, the process of producing NWF by hydro-entanglement may provide products with different stiffness, elasticity, permeability to air, etc. Therefore, this process is not described in detail.

In accordance with a preferred embodiment of the present invention, the synthetic and/or artificial fibers of said barrier layer 20 have a count between 0.8 dtex and 5 dtex. It has been verified that the selection of this range of fiber count promotes a regularity in the distribution of the fibers, a factor that improves the performance in respect of the barrier effect and sound absorption.

The synthetic and/or artificial fibers of said barrier layer 20 may be selected from the group consisting of polyethylene terephthalate (PET) fibers, polybutylene terephthalate (PBT) fibers, polyethylene naphthalate (PEN) fibers, polycyclohexylenedimethylene terephthalate (PCT) fibers, polytrimethylene terephthalate (PTT) fibers, polytrimethylene naphthalate (PTN) fibers, polypropylene (PP) fibers, splittable fibers, and viscose fibers (RY). Preferably, the synthetic fibers of said barrier layer 20 are polyethylene terephthalate (PET) fibers.

Advantageously, the synthetic fibers of said barrier layer 20 may additionally comprise bicomponent fibers.

The bicomponent fibers may have different cross-sections: in the form of adjacent segments (side-by-side); in the form of concentric layers (core-sheath); in the form of fibrils and matrix (island in the sea, segmented). The bicomponent fibers may also be of a different chemical composition (CoPET/PET, PP/PE, PE/PET, etc.). Preferably, the bicomponent fibers are present with a percentage by weight on the barrier layer 20 from 20% to 40%. As will be discussed below, the presence of the bicomponent fibers is intended to allow thermobonding between the first layer 10 and the barrier layer 20.

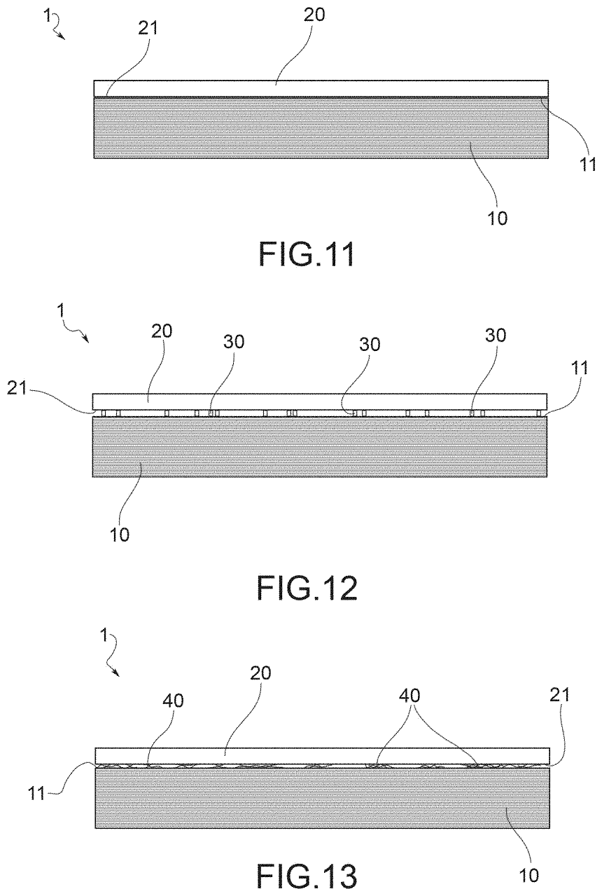

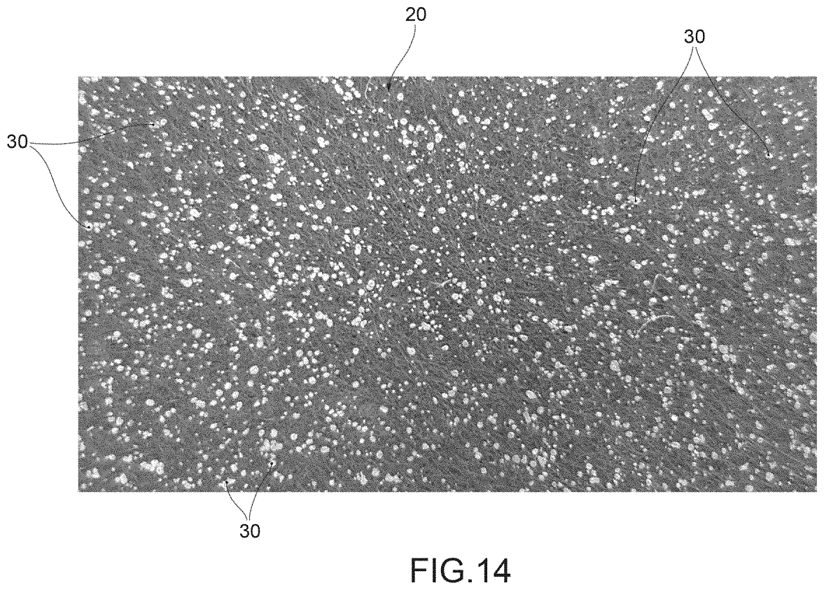

According to a first embodiment of the invention, illustrated schematically in FIG. 11, the first layer 10 and the barrier layer 20 may be simply overlapped on one another without being coupled/interconnected, i.e., without being solidarized with each other.

Preferably, however, the first layer 10 and the barrier layer 20 are also solidarized with each other in such a way that the two layers are locked together so that the composite material 1 becomes a single body that is more easily machined and handled. However, the solidarization between the two layers 10 and 20 is achieved through a discontinuous interconnection between the respective contact surfaces 11, 21 of the two layers 10, 20. In fact, this avoids the formation, between the two layers 10 and 20, of a continuous separation interface between the two layers, which for the purpose of acoustic performance would isolate the two layers and prevent their synergistic cooperation. A continuous interconnection between the two layers (for example through a layer of adhesive material applied continuously between the two contact surfaces of the two layers) would cause sound waves passing through the first layer 10 to be reflected, thus limiting the contribution in terms of sound absorption made by the barrier layer 20. By contrast, a discontinuous interconnection between the respective contact surfaces of the two layers 10, 20 significantly reduces the reflection effect of sound waves. In fact, it was verified experimentally that the discontinuous interconnection does not affect the sound absorption properties of the composite material 1, thus maintaining a synergistic effect between the two layers.

In accordance with a second embodiment of the invention, illustrated schematically in FIG. 12, the discontinuous interconnection between the respective contact surfaces 11, 21 of the two layers 10 and 20 is defined by islands 30 of binder resin acting as a bridge between the two layers 10, 20. Thus, there are free zones of passage for sound waves between the two layers 10 and 20 between the islands 30 of thermoplastic resin.

Preferably, such islands 30 of binder resin are obtained:
by depositing binder resin powder on the contact surface 11 of the first layer 10 and/or on the contact surface 21 of the barrier layer 20 by a scattering dispenser;
by then thermally activating the binder resin powder deposited on the contact surface by applying heat (for example through an IR device);
after overlapping the two layers, by pressing the two layers together (preferably without heating by calendering cylinders), so as to compress the partially molten binder resin powder between the two contact surfaces and thus create said islands 30 of binder resin acting as a bridge between the two layers 10, 20.

Preferably, the islands 30 of binder resin constitute from 3% to 8% by weight of the total weight of the composite material 1. It could be verified that this amount of resin is sufficient to ensure adequate solidarization of the two layers without affecting the sound absorption performance of the composite material 1.

Preferably, the binder resin (and thus the islands formed thereby) is present with a basis weight between 6 g/m2 and 56 g/m2; in particular, the grain size of such resin is in the range of 80 μm to 500 μm.

The binder resin may be co-polyester, polyolefin or epoxy.

In accordance with a third embodiment of the invention, illustrated in FIG. 13, in the case where at least one of the two layers 10 and 20 comprises bicomponent fibers, the discontinuous interconnection between the respective contact surfaces 11, 21 of the two layers 10 and 20 is obtained by thermobonding and is defined by bridge structures 40 between the fibers of the two layers consisting of thermobonded bicomponent fibers.

The present invention relates to a method for making the composite material with molten polymer barrier effect and with flame-retardant properties according to the invention.

For this reason, the method is described below using the same numerical references used to describe the composite material 1. For the description of the composite material 1, reference is made to the description previously provided for the material 1. In addition, the advantages obtainable by the method according to the invention are the same as those described in conjunction with the composite material 1. For simplicity of disclosure, the advantages of the method according to the invention will not be described again either.

In accordance with a general embodiment of the invention, the method for making a composite material 1 with a molten polymer barrier effect and with flame-retardant properties according to the present invention comprises the following operating steps:

a) producing the first layer 10 of non-woven fabric by carding and needling or hydro-entangling a mixture of synthetic fibers with a count between 0.8 dtex and 5 dtex and oxidized polyacrylonitrile fibers with a count between 1.5 and 5 dtex; the oxidized polyacrylonitrile fibers constituting at least 40% by weight of the first layer 10; the first layer 10 has a basis weight between 200 g/m2 and 600 g/m2 and a thickness between 1.6 mm and 5 mm;

b) producing the barrier layer 20 in non-woven fabric by carding and hydro-entangling synthetic and/or artificial fibers; the barrier layer 20 has a basis weight between 70 g/m2 and 150 g/m2, a thickness between 0.4 mm and 1.5 mm and a permeability to air between 200 L/m2s and 2000 L/m2s under a pressure drop of 2 mbar, measured according to ISO 9237,

c) overlapping the first layer 10 and the barrier layer 20 on each other at respective contact surfaces, so as to obtain said composite material.

The composite material 1 obtained has a thickness between 2 mm and 6.5 mm, preferably 3 mm, and a basis weight between 270 g/m2 and 750 g/m2, preferably between 450 g/m2 and 600 g/m2.

The synthetic fibers of said first layer 10 may be selected from the group consisting of polyethylene terephthalate (PET) fibers, polybutylene terephthalate (PBT) fibers, polyethylene naphthalate (PEN) fibers, polycyclohexylenedimethylene terephthalate (PCT) fibers, polytrimethylene terephthalate (PTT) fibers, polytrimethylene naphthalate (PTN) fibers, and polypropylene (PP) fibers. Preferably the other synthetic fibers in said first layer 10 are polyethylene terephthalate (PET) fibers.

Preferably, the synthetic and/or artificial fibers of said barrier layer 20 have a count between 0.8 dtex and 5 dtex.

Advantageously, the other synthetic fibers of said first layer 10 may additionally comprise bicomponent fibers. Preferably, the bicomponent fibers are present with a percentage by weight on the first layer 10 from 20% to 40%.

The synthetic and/or artificial fibers of said barrier layer 20 may be selected from the group consisting of polyethylene terephthalate (PET) fibers, polybutylene terephthalate (PBT) fibers, polyethylene naphthalate (PEN) fibers, polycyclohexylenedimethylene terephthalate (PCT) fibers, polytrimethylene terephthalate (PTT) fibers, polytrimethylene naphthalate (PTN) fibers, polypropylene (PP) fibers, splittable fibers, and viscose fibers (RY). Preferably the synthetic fibers of said barrier layer 20 are polyethylene terephthalate (PET) fibers.

Advantageously, the synthetic and/or artificial fibers of said barrier layer 20 may additionally comprise bicomponent fibers. Preferably, the bicomponent fibers are present with a percentage by weight on the barrier layer 20 from 20% to 40%.

Preferably, the method comprises a step (d) to solidarize the first layer 10 and barrier layer 20 with each other so as to realize a discontinuous interconnection between the respective contact surfaces 11, 21 of the two layers 10, 20.

In accordance with a preferred embodiment, the discontinuous interconnection between the respective contact surfaces of the two layers 10 and 20 is defined by islands 30 of binder resin acting as a bridge between the two layers 10, 20.

Specifically, the above-mentioned solidarizing step d) comprises the following sub-steps conducted prior to the overlapping step (c):

d1) depositing binder resin powder on the contact surface 11 of the first layer 10 and/or on the contact surface 21 of the barrier layer 20;

d2) thermally activating the binder resin powder deposited on the contact surface by applying heat.

The above-mentioned solidarizing step (d) further comprises the following sub-step conducted after the overlapping step (c):

d3) pressing the two overlapped layers 10, 20 together, preferably without heating by calendering cylinders, so as to compress the partially activated binder resin powder between the two contact surfaces 11, 21 and thus create said islands 30 of binder resin acting as a bridge between the two layers 10, 20.

Preferably, the binder resin constitutes from 3% to 8% by weight of the total weight of the composite material 1.

Preferably, the binder resin (and thus the islands formed thereby) is present with a basis weight between 6 g/m2 and 56 g/m2; in particular, the grain size of such resin is in the range of 80 μm to 500 μm.

The binder resin may be co-polyester, polyolefin or epoxy.

In accordance with a preferred alternative embodiment, in the case in which at least one of the two layers 10 and 20 comprises bicomponent fibers, the discontinuous interconnection between the respective contact surfaces 11, 21 of the two layers 10 and 20 is defined by bridge structures 40 between the fibers of the two layers consisting of thermobonded bicomponent fibers.

In such a case, the aforementioned solidarizing step d) comprises thermobonding the two layers 10 and 20 overlapped on each other by the application of heat so as to partially melt the bicomponent fibers present in at least one of the two layers and thus create bridge structures 40 between the fibers of the two layers.

### COMPARATIVE EXAMPLES

Several samples of the composite material 1 according to the invention were made. All the samples were tested for sound absorption measurement by impedance tube according to ISO 10534-2.

The thickness of the composite material 1 and of the layers that compose it was measured following the ISO 9073-2 standard which suggests carrying out the measurement by applying a pressure of 0.5 kPa.

The basis weight of the composite material 1 and of the layers that compose it was measured following the ISO 9073-1 standard which suggests carrying out the measurement relative to an area of 500 cm².

All the material samples according to the invention were made by solidarizing together the first layer 10 made of NWF with the barrier layer 20 made of NWF by depositing epoxy/co-polyester resin on the contact surface 21 of the barrier layer 20 in an amount of 15 g/m2 using a scattering dispenser. The resin, once deposited, was thermally activated. The two layers were then overlapped by pressing them together by calendering cylinders, operating without heating.

In examples 1 to 5, the composite material samples 1 according to the invention all have the same barrier layer 20, while the characteristics of the first layer 10 have been varied, particularly the basis weight and the thickness.

In examples 6 to 10, the samples of composite material 1 according to the invention all have a first layer 10 having substantially the same characteristics (varying only slightly in thickness), while the characteristics of the barrier layer 20 have been varied, in particular the basis weight, thickness, and fiber composition.

The same test of measuring sound absorption by impedance tube according to ISO 10534-2 was carried out on a sample of a commercially available material with a similar function (hereafter identified as “reference material”), for a comparison of acoustic properties with the composite material according to the invention.

The reference material (made according to the teaching of international application WO2020245735A1) comprises an NWF layer based on oxidized PAN fibers and a continuous film of thermoplastic powder deposited by coating on the oxidized PAN fiber layer. Such material has a thickness of 3 mm and basis weight of 600 g/m2.

### Example 1

The characteristics of the sample (prototype) of composite material according to the invention used in example 1 are summarized in Table 1 below:

TABLE 1

| | Basis weight | Thickness | Permeability@−2 mbar | |
|---|---|---|---|---|
| | (g/m²) | (mm) | (L/m² s) | Composition |
| Prototype | 565 | 3 | 258 | |

Made with:

| | | | | |
|---|---|---|---|---|
| barrier layer | 100 | 1 | 1700 | 100% polyester fibers 1.6 dtex |
| (Layer B-1) | | | | NWF made by carding and |
| | | | | hydro-entanglement with |
| | | | | spunlace process |
| First layer | 450 | 2 | | 40% oxidized PAN fibers 2 dtex |
| (Layer A) | | | | 60% polyester fibers 1.7 dtex |
| | | | | NWF made by carding and |
| | | | | needling |

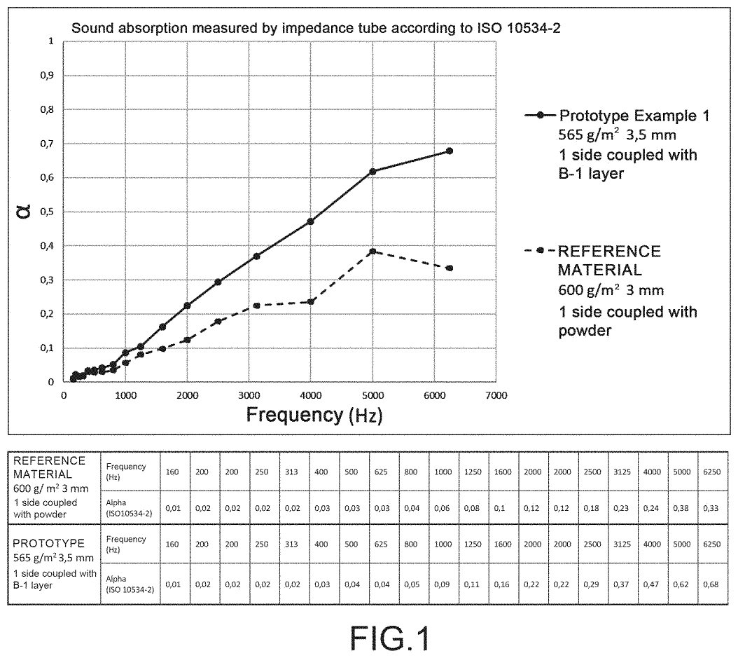

The results of the sound absorption measurement tests are shown in the graph and table in FIG. 1. The same FIG. 1 shows the results of the measurement tests on the sample of the reference material.

The sample of composite material 1 according to the invention exhibits markedly improved sound absorption properties compared to the reference material of higher basis weight, a characteristic that, other things being equal, improves acoustic properties.

The improvement in the sound absorption property may be attributed particularly to the presence of the NWF barrier layer 20 (Layer B-1).

### Example 2

The characteristics of the sample (prototype) of composite material according to the invention used in Example 2 are summarized in Table 2 below:

TABLE 2

| | Basis weight | Thickness | Permeability@−2 mbar | |
|---|---|---|---|---|
| | (g/m²) | (mm) | (L/m² s) | Composition |
| Prototype | 450 | 3.5 | 400 | |

Made with:

| | | | | |
|---|---|---|---|---|
| barrier layer | 100 | 1 | 1700 | 100% polyester fibers 1.6 dtex |
| (Layer B-1) | | | | NWF made by carding and |
| | | | | hydro-entanglement with |
| | | | | spunlace process |
| First layer | 335 | 2.5 | | 40% oxidized PAN fibers 2 dtex |
| (Layer A) | | | | 60% polyester fibers 1.7 dtex |
| | | | | NWF made by carding and |
| | | | | needling |

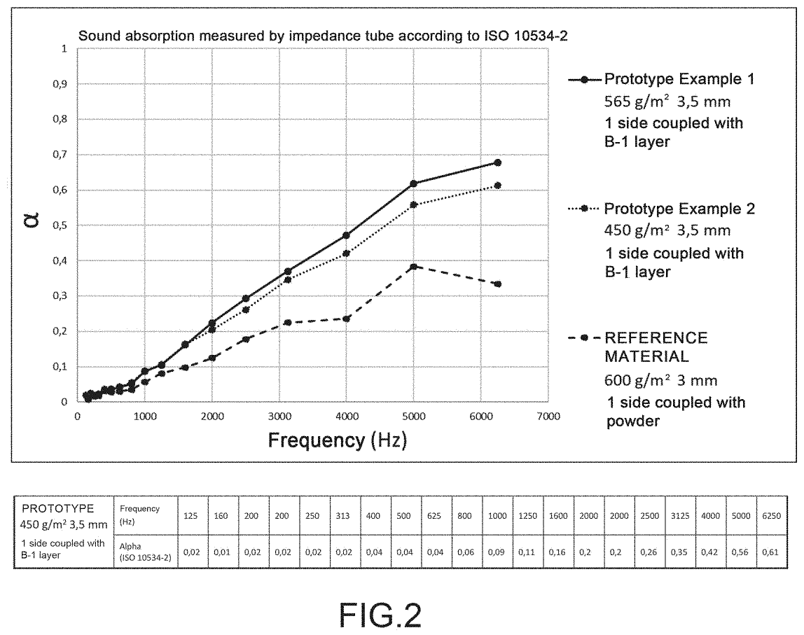

The results of the sound absorption measurement tests are shown in the graph and table in FIG. 2. The graph in the same FIG. 2 shows the results of the measurement tests on the sample of the reference material and on the prototype of example 1.

### Example 3

The characteristics of the sample (prototype) of composite material according to the invention used in Example 3 are summarized in Table 3 below:

TABLE 3

| | Basis weight | Thickness | Permeability@−2 mbar | |
|---|---|---|---|---|
| | (g/m²) | (mm) | (L/m² s) | Composition |
| Prototype | 350 | 3.5 | 550 | |

Made with:

| | | | | |
|---|---|---|---|---|
| barrier layer | 100 | 1 | 1700 | 100% polyester fibers 1.6 dtex |
| (Layer B-1) | | | | NWF made by carding and |
| | | | | hydro-entanglement with |
| | | | | spunlace process |
| First layer | 235 | 2.5 | | 40% oxidized PAN fibers 2 dtex |
| (Layer A) | | | | 60% polyester fibers 1.7 dtex |
| | | | | NWF made by carding and |
| | | | | needling |

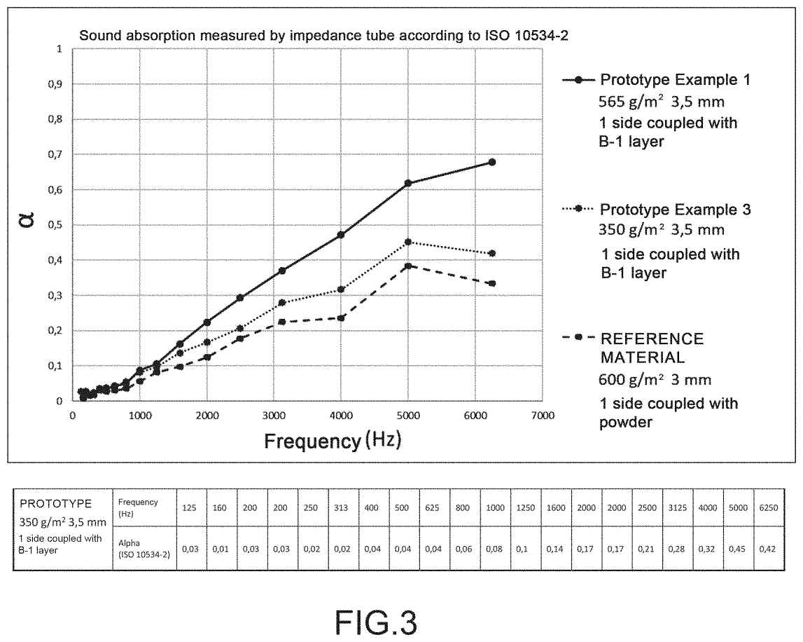

The results of the sound absorption measurement tests are shown in the graph and table in FIG. 3. The graph in the same FIG. 3 shows the results of the measurement tests on the sample of the reference material and on the prototype of example 1.

### Example 4

The characteristics of the sample (prototype) of composite material according to the invention used in example 4 are summarized in Table 4 below:

TABLE 4

| | Basis weight | Thickness | Permeability@−2 mbar | |
|---|---|---|---|---|
| | (g/m²) | (mm) | (L/m² s) | Composition |
| Prototype | 270 | 3 | 750 | |

Made with:

| | | | | |
|---|---|---|---|---|
| barrier layer | 100 | 1 | 1700 | 100% polyester fibers 1.6 dtex |
| (Layer B-1) | | | | NWF made by carding and |
| | | | | hydro-entanglement with |
| | | | | spunlace process |
| First layer | 155 | 2 | | 40% oxidized PAN fibers 2 dtex |
| (Layer A) | | | | 60% polyester fibers 1.7 dtex |
| | | | | NWF made by carding and |
| | | | | needling |

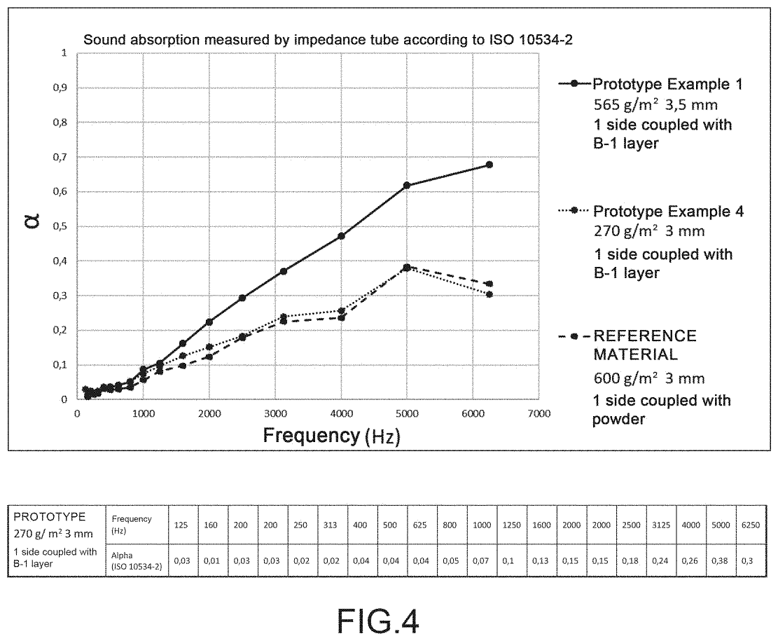

The results of the sound absorption measurement tests are shown in the graph and table in FIG. 4. The graph in the same FIG. 4 shows the results of the measurement tests on the sample of the reference material and on the prototype of example 1.

### Example 5

The characteristics of the sample (prototype) of composite material according to the invention used in example 5 are summarized in Table 5 below:

TABLE 5

| | Basis weight | Thickness | Permeability@−2 mbar | |
|---|---|---|---|---|
| | (g/m²) | (mm) | (L/m² s) | Composition |
| Prototype | 210 | 2 | 917 | |

Made with:

| | | | | |
|---|---|---|---|---|
| barrier layer | 100 | 1 | 1700 | 100% polyester fibers 1.6 dtex |
| (Layer B-1) | | | | NWF made by carding and |
| | | | | hydro-entanglement with |
| | | | | spunlace process |
| First layer | 95 | 1 | | 40% oxidized PAN fibers 2 dtex |
| (Layer A) | | | | 60% polyester fibers 1.7 dtex |
| | | | | NWF made by carding and |
| | | | | needling |

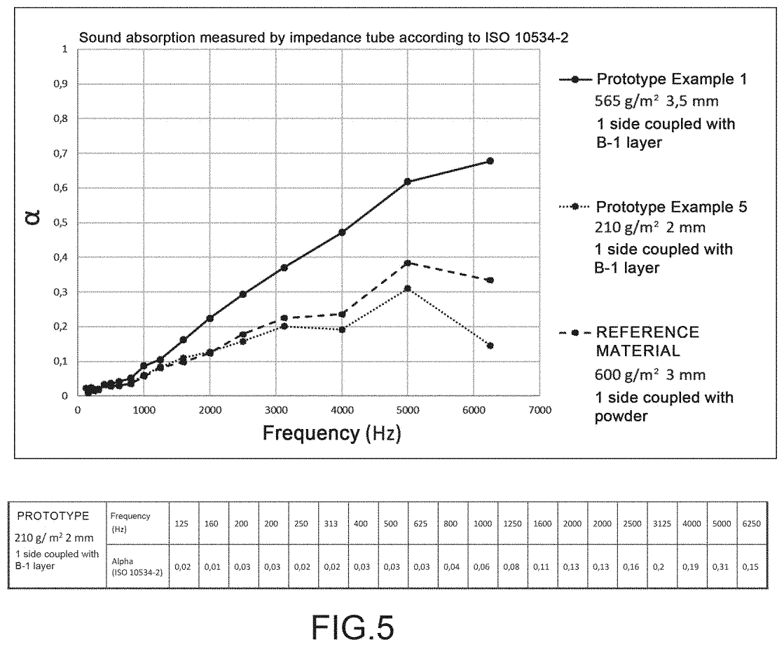

The results of the sound absorption measurement tests are shown in the graph and table in FIG. 5. The graph in the same FIG. 5 shows the results of the measurement tests on the sample of the reference material and on the prototype of example 1.

The sound absorption properties of the PROTOTYPES made in examples 1 to 5 show an improvement in sound absorption as the basis weight and thickness increase. The results obtained were also compared with those for the reference material.

The prototype in example 4 having a basis weight 270 g/m2 and thickness 3.0 mm exhibits sound absorption properties comparable with those of the reference material having a basis weight 600 g/m2 and thickness 3 mm. Thus, it may be seen that the addition of barrier layer 20 made of NWF (layer B) to the first layer 20 based on oxidized PAN fibers makes it possible to obtain the same sound absorption properties as compared with the product found on the market (provided with a barrier through the application of a layer of thermoplastic powder), but with said product having double the basis weight. Reducing the basis weight of the products used as plastics injection barriers is one of the requirements constantly pursued and sought after in the market.

### Example 6

The characteristics of the sample (prototype) of composite material according to the invention used in example 6 are summarized in Table 6 below:

TABLE 6

| | Basis weight | Thickness | Permeability@−2 mbar | |
|---|---|---|---|---|
| | (g/m²) | (mm) | (L/m² s) | Composition |
| Prototype | 350 | 3 | 625 | |

Made with:

| | | | | |
|---|---|---|---|---|
| barrier layer | 100 | 1 | 1700 | 100% polyester fibers 1.6 dtex |
| (Layer B-1) | | | | NWF made by carding and |
| | | | | hydro-entanglement with |
| | | | | spunlace process |
| First layer | 235 | 2 | | 40% oxidized PAN fibers 2 dtex |
| (Layer A) | | | | 60% polyester fibers 1.7 dtex |
| | | | | NWF made by carding and |
| | | | | needling |

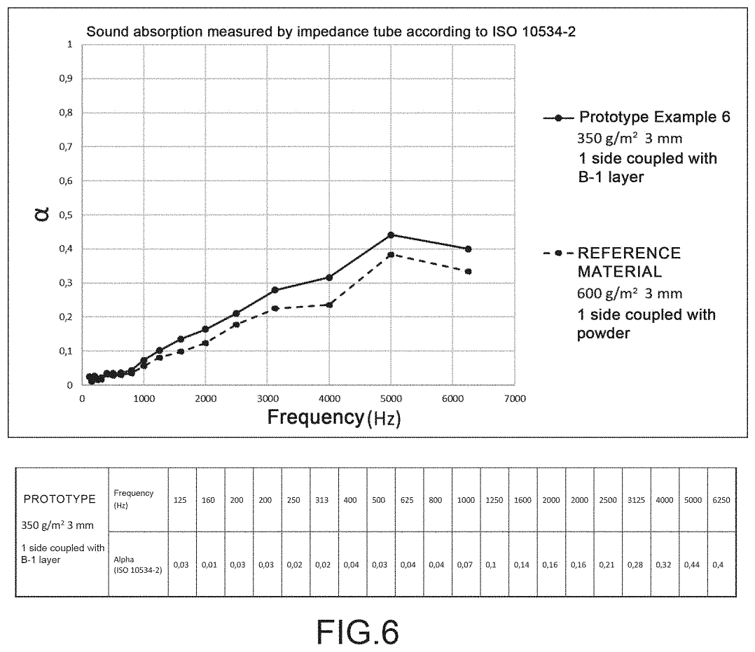

The results of the sound absorption measurement tests are shown in the graph and table in FIG. 6. The same FIG. 6 shows the results of the measurement tests on the sample of the reference material.

### Example 7

The characteristics of the sample (prototype) of composite material according to the invention used in example 7 are summarized in Table 7 below:

TABLE 7

| | Basis weight | Thickness | Permeability@−2 mbar | |
|---|---|---|---|---|
| | (g/m²) | (mm) | (L/m² s) | Composition |
| Prototype | 340 | 3 | 450 | |

Made with:

| | | | | |
|---|---|---|---|---|
| barrier layer | 90 | 0.6 | 800 | 60% splittable |
| (Layer B-2) | | | | polyester/polyamide fibers |
| | | | | 2.2 dtex |
| | | | | 40% polyester fibers 1.3 dtex |
| | | | | NWF made by carding and |
| | | | | hydro-entanglement with |
| | | | | spunlace process |
| First layer | 235 | 2.4 | | 40% oxidized PAN fibers 2 dtex |
| (Layer A) | | | | 60% polyester fibers 1.7 dtex |
| | | | | NWF made by carding and |
| | | | | needling |

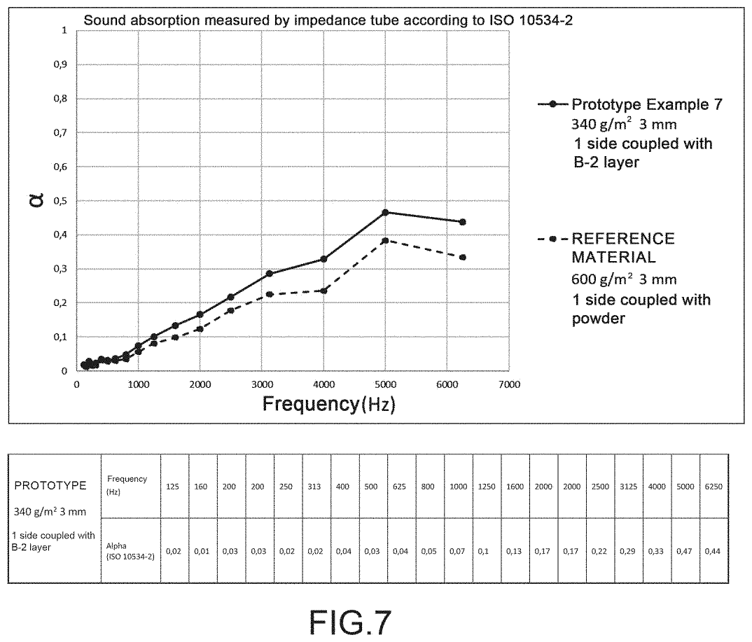

The results of the sound absorption measurement tests are shown in the graph and table in FIG. 7. The same FIG. 7 shows the results of the measurement tests on the sample of the reference material.

### Example 8

The characteristics of the sample (prototype) of composite material according to the invention used in example 8 are summarized in Table 8 below:

TABLE 8

| | Basis weight | Thickness | Permeability@−2 mbar | |
|---|---|---|---|---|
| | (g/m²) | (mm) | (L/m² s) | Composition |
| Prototype | 365 | 3 | 433 | |

Made with:

| | | | | |
|---|---|---|---|---|
| barrier layer | 115 | 0.75 | 700 | 100% viscose fibers 1.7 dtex |
| (Layer B-3) | | | | NWF made by carding and |
| | | | | hydro-entanglement |
| | | | | with spunlace process |
| First layer | 235 | 2.25 | | 40% oxidized PAN fibers 2 dtex |
| (Layer A) | | | | 60% polyester fibers 1.7 dtex |
| | | | | NWF made by carding and |
| | | | | needling |

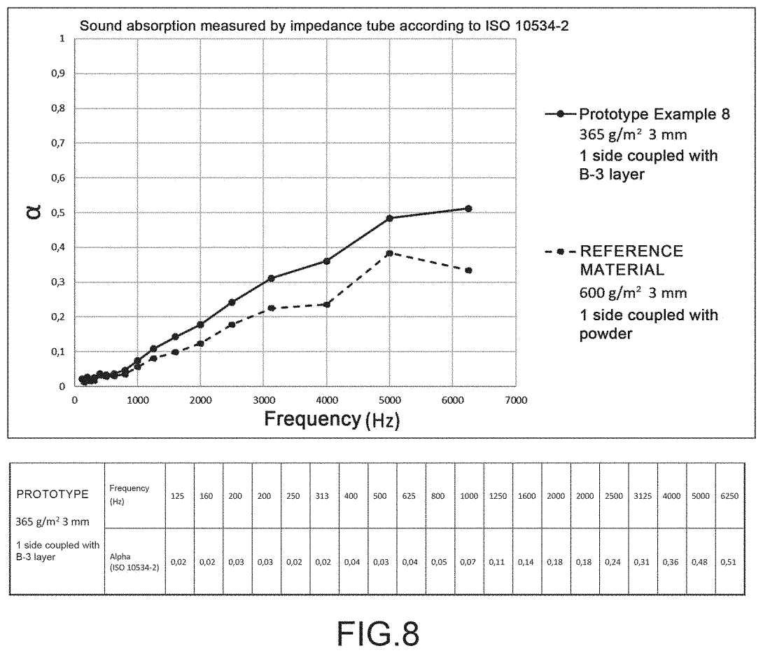

The results of the sound absorption measurement tests are shown in the graph and table in FIG. 8. The same FIG. 8 shows the results of the measurement tests on the sample of the reference material.

### Example 9

The characteristics of the sample (prototype) of composite material according to the invention used in example 9 are summarized in Table 9 below:

TABLE 9

| | Basis weight | Thickness | Permeability@−2 mbar | |
|---|---|---|---|---|
| | (g/m²) | (mm) | (L/m² s) | Composition |
| Prototype | 320 | 3 | 375 | |

Made with:

| | | | | |
|---|---|---|---|---|
| barrier layer | 70 | 0.6 | 600 | 100% splittable |
| (Layer B-4) | | | | polyester/polyamide fibers |
| | | | | 2.2 dtex |
| | | | | NWF made by carding and |
| | | | | hydro-entanglement with |
| | | | | spunlace process |
| First layer | 235 | 2.4 | | 40% oxidized PAN fibers 2 dtex |
| (Layer A) | | | | 60% polyester fibers 1.7 dtex |
| | | | | NWF made by carding and |
| | | | | needling |

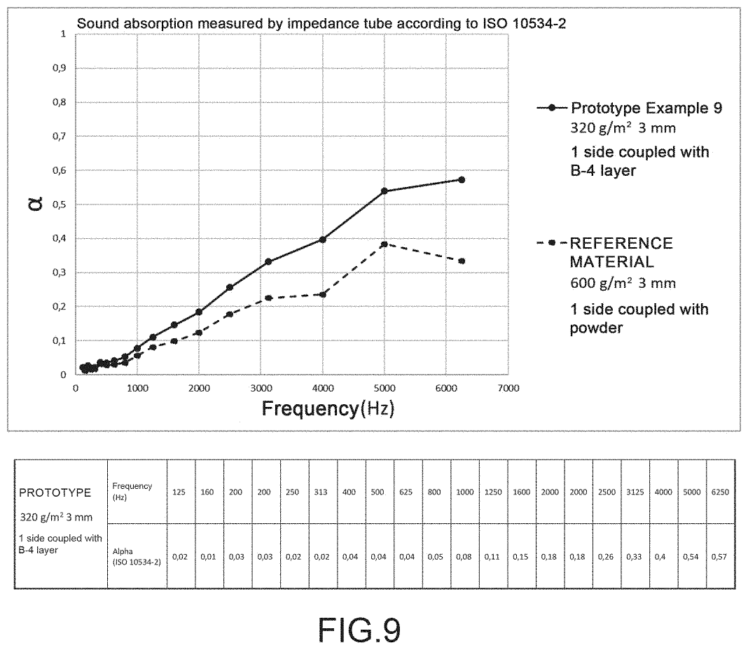

The results of the sound absorption measurement tests are shown in the graph and table in FIG. 9. The same FIG. 9 shows the results of the measurement tests on the sample of the reference material.

### Example 10

The characteristics of the sample (prototype) of composite material according to the invention used in example 6 are summarized in Table 10 below:

TABLE 10

| | Basis weight | Thickness | Permeability@−2 mbar | |
|---|---|---|---|---|
| | (g/m²) | (mm) | (L/m² s) | Composition |
| Prototype | 350 | 3 | 192 | |

Made with:

| | | | | |
|---|---|---|---|---|
| barrier layer | 100 | 0.8 | 250 | 100% splittable |
| (Layer B-5) | | | | polyester/polyamide fibers |
| | | | | 2.2 dtex |
| | | | | NWF made by carding and |
| | | | | hydro-entanglement with |
| | | | | spunlace process |
| First layer | 235 | 2.2 | | 40% oxidized PAN fibers 2 dtex |
| (Layer A) | | | | 60% polyester fibers 1.7 dtex |
| | | | | NWF made by carding and |
| | | | | needling |

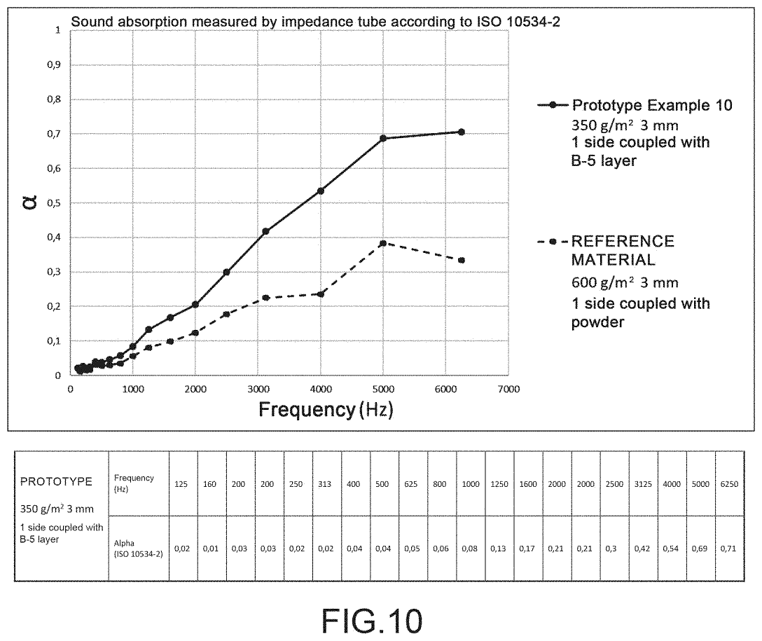

The results of the sound absorption measurement tests are shown in the graph and table in FIG. 10. The same FIG. 10 shows the results of the measurement tests on the sample of the reference material.

In examples 6 to 10, prototypes of composite material 1 according to the invention in which the basis weight of the first layer 10 (layer A) was kept constant were tested, combining barrier layers 20 (layers B) made with the same spunlace technology but having different characteristics: basis weight, thickness, permeability and fiber composition.

The various barrier layers 20 (layers B) show different basis weight and permeability characteristics with effective barrier capacity since they may be used depending on the applications to different molding systems. The final thickness of the prototypes was kept constant at 3 mm.

The sound absorption properties of the various prototypes having the same thickness and similar basis weight whilst varying the nature of the coupled barrier layer 20 (layer B), and in particular with different permeability and fiber composition, vary greatly.

It was shown that, as the permeability of the coupled barrier layer 20 (layer B) decreased (progressive decrease from the prototype of example 6 to the prototype of example 10), the sound absorption property improved with other factors being equal.

All of the prototypes tested showed an improvement in sound absorption compared to the reference material, despite having almost half the basis weight, a difference that was maximized in the PROTOTYPE made in example 10.

Table 11 below shows the tensile characteristic data of the composite material 1 according to the invention used in example 1, as well as the tensile characteristic data of the reference material on the market.

TABLE 11

| | | | REFERENCE | Material |
|---|---|---|---|---|
| | | | MATERIAL | Example 1 |
| | Reference | Unit of | with powder | 1 side coupled |
| Feature | standard | measurement | on one side | to layer B-1 |
| Basis weight | ISO 9073-1 | g/m2 | 600 | 565 |
| Thickness | ISO 9073-2 | mm | 3 | 3.5 |
| Max load MD | ISO 9073-3 | N/5 cm | 267 | 607 |
| Max elongation MD | | % | 57 | 66 |
| Max load CD | | N/5 cm | 368 | 786 |
| Max elongation CD | | % | 64 | 74 |
| Permeability −2 mbar | ISO 9237 | l/m2 sec | 367 | 258 |

It is observed that the product of the present invention has a much higher tensile strength than the reference material on the market; in addition, the greater elongations ensure better adaptability to the complex shapes in the molding step.

The invention allows numerous advantages to be obtained, which have already been described in part.

The composite material with a molten polymer barrier effect and with flame-retardant properties according to the invention has a high sound absorption capacity.

The composite material with a molten polymer barrier effect and with flame-retardant properties according to the invention makes it possible to improve the barrier effect to the passage of molten plastics material. In fact, compared with a material with similar functions described in WO2020245735A1, in the composite material according to the invention the presence of a barrier layer made of a hydro-entangled non-woven fabric that entirely covers the surface of the oxidized PAN fiber-based layer (with high fire and heat resistance) avoids passage irregularities at the time of injection that might occur instead in a barrier layer obtained by coating of a thermoplastic material.

The composite material with a molten polymer barrier effect and with flame-retardant properties according to the invention also exhibits constant dimensional stability in the molding processes, particularly in the molding processes for automotive components.

In fact, the barrier layer made of hydro-entangled non-woven fabric turns out to be easily deformable and adaptable to even the most complex geometries, significantly increasing the sound absorption properties, a characteristic that is very appreciable in different parts of the car.

Due to being made by hydro-entanglement, the barrier layer maintains the fiber elongation properties in both machine directions with effective performance improvement during the molding process; the barrier layer may be easily adapted to the mold shape while maintaining the structural integrity and barrier properties of the material used for the molding itself.

Thus, the composite material according to the invention is a valuable aid to automotive component manufacturers to increase the efficiency of the one-step injection molding process, reduce quality defects, and potentially save on production costs.

The composite material with molten polymer barrier effect and with flame-retardant properties according to the invention is easy to produce since it may be made by traditional non-woven fabric production processes.

Compared with a material made in accordance with international application WO 2020/245735 A1 (NWF layer with oxidized PAN fibers coated with polyethylene-based thermoplastic resin), in the composite material according to the invention, due to the presence of a hydro-entangled NWF barrier layer, it is possible to reduce the basis weight of the layer containing the oxidized PAN fibers. In fact, the hydro-entangled NWF has a greater thickness than a thermoplastic resin sheet, and to achieve the thickness required by the application, it is possible to vary the combination of the thicknesses of the two layers.

The composite material component according to the present invention based on oxidized PAN fibers carbonizes when attacked by a flame, thus forming a kind of surface ‘char’ layer; the flame then encounters the NWF barrier layer, which surely melts at a higher temperature than polyethylene (whether PES, PP, PA, etc.). Thus, the composite material according to the invention has a higher fire resistance than a product made according to WO 2020/245735 A1.

The reduction of the oxidized PAN fiber-based layer is offset by the hydro-entangled NWF barrier layer, bringing a cost reduction advantage. The oxidized PAN fiber costs much more than the thermoplastic fibers normally used.

The invention thus conceived therefore achieves its intended objects.

Obviously, in practice it may also assume different forms and configurations from the one illustrated above, without thereby departing from the present scope of protection.

Furthermore, all details may be replaced with technically equivalent elements, and the dimensions, shapes, and materials used may be any according to the needs.

1. A composite material with molten polymer barrier effect and with flame-retardant properties, comprising:
a first layer of non-woven fabric comprising a percentage by weight of oxidized polyacrylonitrile fibres equal to or greater than 40% to confer flame-retardant properties to the composite material, the remaining percentage by weight including other synthetic fibres, said first layer having a weight between 200 g/m2 and 600 g/m2 and a thickness between 1.6 mm and 5 mm;
a barrier layer, overlapping said first layer and configured to counteract passage of molten polymers through said composite material;
wherein the oxidized polyacrylonitrile fibres of said first layer have a count between 1.5-5 dtex, and the other synthetic fibres of said first layer have a count between 0.8 dtex and 5 dtex; and
wherein the barrier layer comprises a second layer of non-woven fabric of hydro-entangled synthetic and/or artificial fibres, said barrier layer having: a basis weight between 70 g/m2 and 150 g/m2; a thickness between 0.4 mm and 1.5 mm; and a permeability to air between 200 L/m2s and 2000 L/m2s under a pressure drop of 2 mbar, measured in accordance with ISO 9237;
wherein the composite material has a thickness between 2 mm and 6.5 mm, and a basis weight between 270 g/m2 and 750 g/m2.

2. The composite material according to claim 1, wherein the other synthetic fibres of said first layer are selected from the group consisting of polyethylene terephthalate (PET) fibres, polybutylene terephthalate (PBT) fibres, polyethylene naphthalate (PEN) fibres, polycyclohexylenedimethylene terephthalate (PCT) fibres, polytrimethylene terephthalate (PTT) fibres, polytrimethylene naphthalate (PTN) fibres, polypropylene fibres (PP).

3. The composite material according to claim 1, wherein the synthetic and/or artificial fibres of said barrier layer have a count between 0.8 dtex and 5 dtex.

4. The composite material according to claim 1, wherein the synthetic and/or artificial fibres of said barrier layer are selected from the group consisting of polyethylene terephthalate (PET) fibres, polybutylene terephthalate (PBT) fibres, polyethylene naphthalate (PEN) fibres, polycyclohexylenedimethylene terephthalate (PCT) fibres, polytrimethylene terephthalate (PTT) fibres, polytrimethylene naphthalate (PTN) fibres, polypropylene fibres (PP), splittable fibres, viscose fibres (RY).

5. The composite material according to claim 1, wherein the first layer and the barrier layer are solidarized with each other by a discontinuous interconnection between the respective contact surfaces of the two layers.

6. The composite material according to claim 5, wherein the discontinuous interconnection between the respective contact surfaces of the two layers is defined by islands of binder resin acting as a bridge between the two layers.

7. The composite material according to claim 6, wherein said islands of binder resin comprise 3% to 8% by weight on the total weight of the composite material.

8. The composite material according to claim 6, wherein said binder resin comprises co-polyester, polyolefin or epoxy.

9. The composite material according to claim 2, wherein the other synthetic fibres of said first layer further comprise bicomponent fibres.

10. The composite material according to claim 4, wherein the synthetic and/or artificial fibres of said barrier layer further comprise bicomponent fibres.

11. The composite material according to claim 9, wherein the first layer and the barrier layer are solidarized with each other by a discontinuous interconnection between respective contact surfaces of the two layers and wherein the discontinuous interconnection between the respective contact surfaces of the two layers is defined by bridge structures between the fibres of the two layers comprising thermobonded bicomponent fibres.

12. A method for making a composite material with molten polymer barrier effect and with flame-retardant properties according to claim 1, comprising the following operating steps:
a) producing the first layer of non-woven fabric by carding and needling or hydro-entangling a mixture of other synthetic fibres with a count between 0.8 dtex and 5 dtex and oxidized polyacrylonitrile fibres with a count between 1.5 and 5 dtex, the oxidized polyacrylonitrile fibres comprising at least 40% by weight of the first layer, said first layer having a basis weight between 200 g/m2 and 600 g/m2 and a thickness between 1.6 mm and 5 mm;
b) producing the barrier layer in non-woven fabric by carding and hydro-entangling synthetic and/or artificial fibres, said barrier layer having a basis weight between 70 g/m2 and 150 g/m2, a thickness between 0.4 mm and 1.5 mm and a permeability to air between 200 L/m2s and 2000 L/m2s under a pressure drop of 2 mbar, measured according to ISO 9237;
c) overlapping the first layer and the barrier layer on each other at respective contact surfaces, to obtain said composite material;
wherein the composite material has a thickness between 2 mm and 6.5 mm, and a basis weight between 270 g/m2 and 750 g/m2.

13. The method according to claim 12, wherein the other synthetic fibres of said first layer are selected from the group consisting of polyethylene terephthalate (PET) fibres, polybutylene terephthalate (PBT) fibres, polyethylene naphthalate (PEN) fibres, polycyclohexylenedimethylene terephthalate (PCT) fibres, polytrimethylene terephthalate (PTT) fibres, polytrimethylene naphthalate (PTN) fibres, polypropylene (PP) fibres.

14. The method according to claim 12, wherein the synthetic and/or artificial fibres of said barrier layer have a count between 0.8 dtex and 5 dtex.

15. The method according to claim 12, wherein the synthetic and/or artificial fibres of said barrier layer are selected from the group consisting of polyethylene terephthalate (PET) fibres, polybutylene terephthalate (PBT) fibres, polyethylene naphthalate (PEN) fibres, polycyclohexylenedimethylene terephthalate (PCT) fibres, polytrimethylene terephthalate (PTT) fibres, polytrimethylene naphthalate (PTN) fibres, polypropylene fibres (PP), splittable fibres, viscose fibres (RY).

16. The method according to claim 12, comprising a step d) of solidarizing the first layer and the barrier layer together to make a discontinuous interconnection between the respective contact surfaces of the two layers.

17. The method according to claim 16, wherein the discontinuous interconnection between the respective contact surfaces of the two layers is defined by islands of binder resin acting as a bridge between the two layers.

18. The method according to claim 17, wherein said solidarizing step d) comprises the following sub-steps conducted prior to the overlapping step c):
d1) depositing binder resin powder on the contact surface of the first layer and/or on the contact surface of the barrier layer;
d2) thermally activating the binder resin powder deposited on the contact surface by applying heat;
wherein said solidarizing step d) further comprises the following sub-step conducted after the overlapping step c):
d3) pressing the two overlapped layers together, to compress the binder resin powder between the two contact surfaces and create said islands of binder resin acting as a bridge between the two layers.

19. The method according to claim 17, wherein said binder resin comprises from 3% to 8% by weight of the total weight of the composite material.

20. The method according to claim 17, wherein said binder resin comprises co-polyester, polyolefin or epoxy.

21. The method according to claim 13, wherein the other synthetic fibres of said first layer further comprise bicomponent fibres.

22. The method according to claim 15, wherein the synthetic and/or artificial fibres of said barrier layer further comprise bicomponent fibres.

23. The method according to claim 21, comprising a step d) of solidarizing the first layer and the barrier layer together to make a discontinuous interconnection between respective contact surfaces of the two layers, wherein the discontinuous interconnection between the respective contact surfaces of the two layers is defined by bridge structures between the fibres of the two layers consisting of thermobonded bicomponent fibres.

24. The method according to claim 23, wherein said solidarizing step d) comprises thermobinding the two layers overlapped on each other by application of heat to partially melt the bicomponent fibres and create bridge structures between the fibres of the two layers.
